(19) United States
(12) Patent Application Publication
(10) Pub. No.: US 2026/0164255 A1
(43) Pub. Date: Jun. 11, 2026

(54) GUIDED POSITIONING BASED ON WIRELESS NETWORK PERFORMANCE

(71) Applicants: AT&T Intellectual Property I, L.P., Atlanta, GA (US); AT&T Mobility II LLC, Atlanta, GA (US)

(72) Inventors: Stephen Hardin, Suwanee, GA (US); Yupeng Jia, South Pasadena, CA (US); Anthony Dalby, Carrollton, TX (US); James H. Pratt, Round Rock, TX (US)

(73) Assignees: AT&T Intellectual Property I, L.P., Atlanta, GA (US); AT&T Mobility II LLC, Atlanta, GA (US)

(21) Appl. No.: 18/976,907

(22) Filed: Dec. 11, 2024

(51) Int. Cl. H04W 16/22; H04W 24/08; H04W 64/00

(52) U.S. Cl. CPC H04W 16/22; H04W 24/08; H04W 64/00

(57) ABSTRACT

Aspects of the subject disclosure may include, for example, obtaining performance data of a wireless network determined by multiple wireless devices at multiple different locations, the performance data describing a performance of the wireless network at the multiple different locations. The network performance data is associated with multiple performance levels or ranges and the network performance data is analyzed according to the multiple performance ranges to identify one or more spatial performance zones according to the performance data, the multiple different locations, and the multiple performance ranges. The operations further include determining user location data of a mobile device and determining performance-based information based at least in part on the user location data and the one or more spatial performance zones. Other embodiments are disclosed.

### FIELD OF THE DISCLOSURE

The subject disclosure relates to guided positioning based on network performance.

### BACKGROUND

The evolution of cellular services has seen significant advancements over the past few decades, transitioning from basic voice communication to high-speed data services. Different levels of cellular service have been developed to meet the increasing demand for faster and more reliable wireless communication. For example, 4G Long Term Evolution (LTE) offers faster download and upload speeds, lower latency, and enhanced support for multimedia applications than other services, such as 3G, delivering data rates of up to 100 Mbps for mobile users and up to 1 Gbps for stationary users, making it suitable for activities such as streaming high-definition video, online gaming, and video conferencing. Other cellular services include 5G (Fifth Generation) and 5G+ (Enhanced 5G Services), offering even higher data rates, lower latencies, and increased network capacities compared to 4G LTE. Such enhancements of cellular services enable new and improved use cases such as autonomous vehicles, smart cities, advanced Internet of Things (IoT) applications, augmented and/or virtual realities.

Access to different levels of cellular service is dependent upon one or more parameters of a wireless communication channel or link between a mobile device and a base station. These parameters can include signal level, signal quality, and supported data rate, which are often indicated by the number of bars displayed on a mobile device. For example, a signal level, as may be represented by a number of bars on a mobile device, can indicate a strength of a wireless signal received from a base station. A higher number of bars typically signifies a stronger signal, which can result in better call quality and faster data speeds. Conversely, a lower number of bars indicates a weaker signal, which may lead to dropped calls and slower data rates.

Thus, the availability and performance of different levels of cellular service, such as 4G LTE, 5G, and 5G+, are influenced by various parameters of the wireless communication channels or links between a mobile device and a base station or access point. Identifying these parameters is crucial for optimizing network performance and ensuring that users have access to the best possible connectivity experience.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a wireless network performance-based guidance system functioning within the communication system of FIG. 1 in accordance with various aspects described herein.

FIG. 2B is a schematic diagram illustrating an example, non-limiting embodiment of a wireless network performance reporting scheme of the wireless network performance-based guidance system of FIG. 2A, functioning within the communication system of FIG. 1 in accordance with various aspects described herein.

FIG. 2C is a block diagram illustrating an example, non-limiting embodiment of a wireless network performance reporting system functioning within the communication system of FIG. 1 in accordance with various aspects described herein.

FIG. 2D is a block diagram illustrating in further detail an example, non-limiting embodiment of a wireless network performance reporting system, functioning within the communication system of FIG. 1 in accordance with various aspects described herein.

FIG. 2E is a block diagram illustrating in still further detail an example, non-limiting embodiment of a wireless network performance reporting system, functioning within the communication system of FIG. 1 in accordance with various aspects described herein.

FIG. 2F is a block diagram illustrating in still further detail an example, non-limiting embodiment of a wireless network performance reporting system, functioning within the communication system of FIG. 1 in accordance with various aspects described herein.

FIG. 2G is a block diagram illustrating in still further detail an example, non-limiting embodiment of a wireless network performance reporting system, functioning within the communication system of FIG. 1 in accordance with various aspects described herein.

FIG. 2H is a block diagram illustrating an example, non-limiting embodiment of a wireless network performance-based guidance system according to an example operational scenario, functioning within the communication system of FIG. 1 in accordance with various aspects described herein.

FIG. 2I is a block diagram illustrating an example, non-limiting embodiment of a wireless network performance-based guidance system according to another example operational scenario, functioning within the communication system of FIG. 1 in accordance with various aspects described herein.

FIG. 2J is a block diagram illustrating an example, non-limiting embodiment of a wireless network performance-based guidance system according to yet another example operational scenario, functioning within the communication system of FIG. 1 in accordance with various aspects described herein.

FIG. 2K is a block diagram illustrating an example, non-limiting embodiment of a wireless network performance-based guidance system according to an example operational scenario, functioning within the communication system of FIG. 1 in accordance with various aspects described herein.

FIG. 2L depicts an illustrative embodiment of a wireless network performance-based guidance process in accordance with various aspects described herein.

FIG. 2M depicts an illustrative embodiment of another wireless network performance-based guidance process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for obtaining performance data of a wireless network determined by multiple wireless devices at multiple different locations, the performance data describing a performance of the wireless network at the multiple different locations. The network performance data is associated with multiple performance ranges and the network performance data is analyzed according to the multiple performance ranges to identify one or more spatial performance zones according to the performance data, the multiple different locations, and the multiple performance ranges. The operations further include determining user location data of a mobile device and determining performance-based information based at least in part on the user location data and the one or more spatial performance zones. Other embodiments are described in the subject disclosure.

One or more aspects of the subject disclosure include a process for presenting to a device, along a route of travel, predicted wireless network performance data for the device. The process includes receiving, by a processing system including a processor, network performance data of a wireless network observed by multiple wireless collector devices at multiple different locations. The network performance data describes a performance of a wireless network at the multiple of different locations. The process further includes receiving, by the processing system, location data describing the multiple different locations of the multiple wireless collector devices. The process further includes differentiating, by the processing system, the network performance data into multiple differentiated network performance ranges. The process further includes analyzing, by the processing system, the network performance data and the location data according to the multiple differentiated network performance ranges to identify one or more spatial performance zones according to the network performance data, the multiple different locations, and the multiple differentiated network performance ranges. The process further includes receiving, by the processing system, user location data originating from a mobile communication device and sending, by the processing system, performance-based information to the mobile communication device. The performance-based information is based at least in part on the user location data and the one or more spatial performance zones.

One or more aspects of the subject disclosure include a device, including a processing system including a processor and a memory that stores executable instructions that, when executed by the processing system, facilitate performance of operations. The operations include obtaining network performance data of a wireless network determined by multiple wireless communication devices at multiple different locations, the network performance data describing performance of the wireless network at the multiple different locations. The operations further include receiving location data describing the multiple different locations of the multiple wireless communication devices. The operations further include associating the network performance data with a plurality of performance ranges and analyzing the network performance data and the location data according to the multiple performance ranges to identify one or more spatial performance zones according to the network performance data, the multiple different locations, and the multiple performance ranges. The operations further include receiving user location data originating from a mobile device and sending performance-based information to the mobile device, wherein the performance-based information is based at least in part on the user location data and the one or more spatial performance zones.

One or more aspects of the subject disclosure include a non-transitory machine-readable medium, comprising executable instructions that, when executed by a processing system, including a processor, facilitate performance of operations. The operations include obtaining performance data of a wireless network determined by multiple wireless devices at multiple different locations, the performance data describing a performance of the wireless network at the multiple different locations. The operations further include associating the network performance data with multiple performance ranges and analyzing the network performance data according to the multiple performance ranges to identify one or more spatial performance zones according to the performance data, the multiple different locations, and the multiple performance ranges. The operations further include determining user location data of a mobile device and determining performance-based information based at least in part on the user location data and the one or more spatial performance zones.

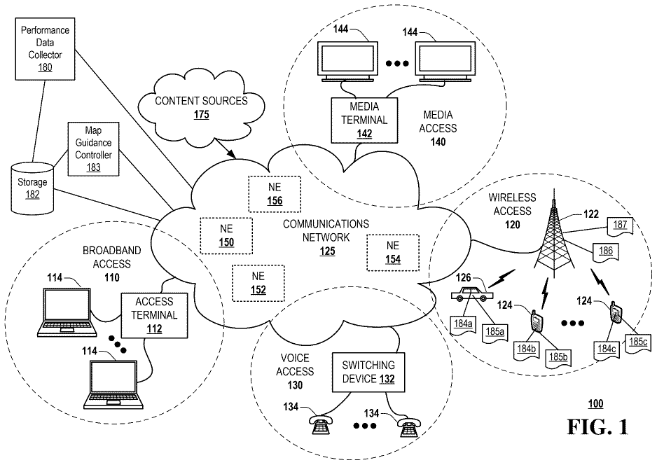

Referring now to FIG. 1, a block diagram is shown illustrating an example, non-limiting embodiment of a communication system 100 in accordance with various aspects described herein. For example, the communication system 100 can facilitate in whole or in part receiving performance data from multiple wireless communication devices at various locations describing wireless network performance at their respective locations, analyzing the data to identify one or more performance zones and providing guidance and/or recommendations to a mobile user device based on the performance zones proximate to the mobile user device. In at least some embodiments, the collected information can include other information, such as device type information and/or application usage in association with the performance data. Guidance and/or recommendations can include, without limitation, advisories, e.g., warning of nearby performance degradations and/or outages, navigation information, e.g., recommended alternate routes based on current and/or planned mobile services and/or advertisements of nearby alternative wireless services, e.g., Wi-Fi hotspots. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

With respect to wireless access, it is recognized that wireless users may encounter fluctuations and/or variations in wireless network performance. Such variations may limit their access to some network services, e.g., 5G, while permitting access at some lower level of service, e.g., 4G LTE. At times, the variations may result in a degradation of an active service, e.g., reducing data transfer rates and/or streaming quality, with the possibility of a complete loss in service. In at least some instances, such wireless network performance variations may be attributable to available wireless signal coverage provided by a mobile service provider. For example, a mobile user may be operating at cell edge and/or in some other region that may experience interference and/or signal blockage, e.g., from hills and/or urban canyons.

It is further recognized that such performance may be attributable, at least in part, to one or more characteristics of the mobile user equipment. There are various makes, models and/or versions of mobile devices, such as smart phones, smart watches, tablets, laptop devices, and the like. In at least some instances, the different devices may perceive different wireless network performance at the same location and under the same network conditions. This may be due, in part, to differences in one or more of antenna configurations, receiver sensitivities, transmitter powers, signal processing, and so on. Accordingly, a problem exists in that wireless users do not currently have access to data that may predict expected wireless network performance for their specific device and configuration. The techniques disclosed herein collect based on the real performance data collected from wireless devices that have sampled wireless performance parameters in nearby locations. This data may be useful for planning routes and understanding the expected wireless performance that might be received along those routes or may also be useful in being able to direct users to nearby locations that have historically provided improved network coverage for users with devices like the user themselves.

To this end, the example communication system 100 includes a performance data collector 180, a performance data store 182 and, in at least some embodiments, a mapping guidance module 183. The performance data collector 180 can be operable to collect data associated with multiple wireless devices, including wireless performance data, and to generate a historical record based on the collected data. In at least some embodiments, the mobile device 124 and/or vehicle 126 can be configured with a mobile wireless performance data monitoring application program (app) 184a, 184b, 184c, generally 184. The mobile wireless performance data monitoring app 184 can be configured to observe and/or otherwise sample one or more parameters indicative of a performance of a wireless communication session. Without limitation, the parameters can include one or more of an RF signal level, a data rate, and a signal quality. In at least some embodiments, the mobile wireless performance data monitoring app 184 can be configured to determine a location associated with each reported performance parameter. For example, the mobile wireless performance data monitoring app 184 may be configured to query a location receiver, e.g., a GPS receiver, of the mobile device 124 and/or vehicle 126 to obtain an approximate location of the device. It is understood that in at least some embodiments, the location information includes geocoordinates, e.g., one or more of a latitude, a longitude and/or an elevation. Alternatively, or in addition, the performance data collector 180, responsive to receiving a reported performance parameter, may obtain an approximate location of the reporting wireless device from the network, e.g., as may be estimated by one or more of power, signal delay, sector orientation, time difference of arrival and/or triangulation.

The performance data collector 180 can operate in a like manner to receive reported performance parameters from multiple wireless devices, e.g., the example mobile device 124 and/or vehicle 126, over an extended period of time, e.g., over the course of several hours, over the course of a day, over the course of several days, weeks, months, years and so on, to establish a historical record of reported performance parameters. In at least some embodiments, the records of reported performance parameters may be stored on the performance data store 182.

Other information that may be collected and/or otherwise associated with reported performance parameters may include one or more of a device type of the reporting mobile device 124 and/or vehicle 126, e.g., as may be distinguished according to a make, model, version and/or any other identifier of a device configuration. In at least some embodiments, the device type information can include version information of software, such as an operating system of the mobile device 124 and/or vehicle 126, and/or the mobile wireless performance data monitoring app 184.

Without limitation, it is understood that reporting wireless devices may include mobile user devices, e.g., cell phones, smart watches, tablet devices, laptops and the like. Alternatively, or in addition, the wireless devices may include machine-type communication capabilities as they may be employed in autonomous vehicles, e.g., self-driving cars, drones and the like. In at least some embodiments, the reporting wireless devices may include stationary devices, such as IoT devices as may be deployed and operable over any particular region of interest. In at least some embodiments, the device type information can include an indication as to whether the device is mobile and/or stationary. To the extent a device is mobile, it is conceivable that reported performance parameters may include and/or otherwise be associated with a speed, acceleration and/or direction of the mobile device 124 and/or vehicle 126. In at least some embodiments, the speed may be calculable from reported position information that may include time stamps permitting determination of changes in distance and associated changes in time. The position and/or time stamp information may be generated by one or more of the mobile device 124 and/or vehicle 126, the network equipment, e.g., the base station or access point 122, and/or the performance data collector 180. For example, in at least some embodiments, the base station or access point 122 may include a network-side, wireless performance data monitoring app 186 configured to configured to observe and/or otherwise sample one or more parameters indicative of the performance of one or more wireless communication sessions. Alternatively, or in addition, the network-side, wireless performance data monitoring app 186 may be configured to supplement information reported by the mobile wireless performance data monitoring app 184 of the mobile device 124 and/or vehicle 126 with information obtained by and/or generated by the network-side, wireless performance data monitoring app 186. Network-side information can include one or more of a device type, a device location, as well as any other wireless performance data determined by the base station or access point 122 and/or reported by the mobile device 124 and/or vehicle 126 to the base station or access point 122.

In at least some embodiments, the example communication system 100 includes a mapping guidance module 183. The mapping guidance module 183 can be operable to determine and/or otherwise provide guidance information to the mobile device 124 and/or vehicle 126, based on historical wireless performance records as may be stored on the performance data store 182. Guidance information can include, without limitation, expected performance criteria, e.g., one or more of an RF signal level, a data rate, and a signal quality. Alternatively, or in addition, the guidance information may provide advisory information, e.g., providing notice regarding a potential change in expected performance criteria, e.g., a loss of signal and/or interference, as may be anticipated according to a path of the mobile device 124 and/or vehicle 126, based on previously reported performance parameters in the same region.

In at least some embodiments, one or more of the wireless device 124 and/or the vehicle 126 can be configured with a mobile guided positioning application program (app) 185a, 185b, 185c, generally 185. The mobile guided positioning app 185 can be configured to observe and/or report, e.g., to the mapping guidance module 183 a current location of a mobile user device and/or otherwise anticipate and/or report a future location of the mobile user device. The mobile guided positioning app 185 and/or the mapping guidance module 183 may be configured to associate, e.g., overlay the current and/or anticipated position of the mobile user device with a map identifying differentiated performance criteria so as to estimate and/or otherwise predict a performance of a wireless communication session at the current and/or anticipated position. To this end, the mobile guided positioning app 185 and/or the mapping guidance module 183 may access records of reported performance parameters stored on the performance data store 182.

In at least some embodiments, the base station or access point 122 may be configured with a guided positioning app 187. The guided positioning app 187 may operate independent and/or in combination, e.g., according to a sharing arrangement, with one or more of the mobile guided positioning app 185 and/or the mapping guidance module 183.

Without limitation, one or more of the performance data collector 180, the performance data store 182 and/or the mapping guidance module 183 may be hosted in whole or in part at a network node and/or distributed across multiple network nodes. Alternatively, or in addition, one or more of the performance data collector 180, the performance data store 182 and/or the mapping guidance module 183 may be hosted in whole or in part at a backend server, e.g., at one or more data centers.

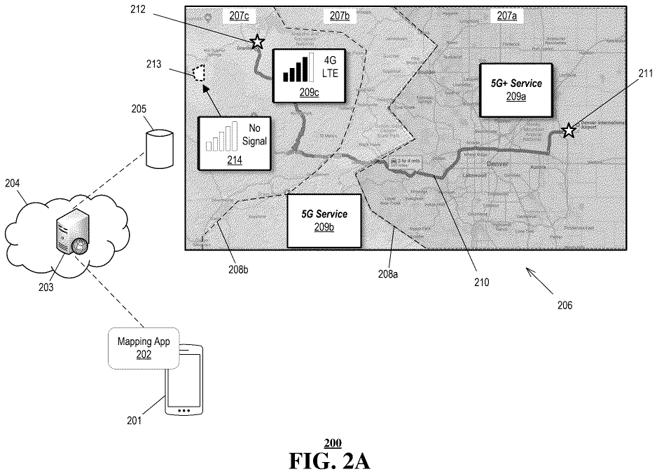

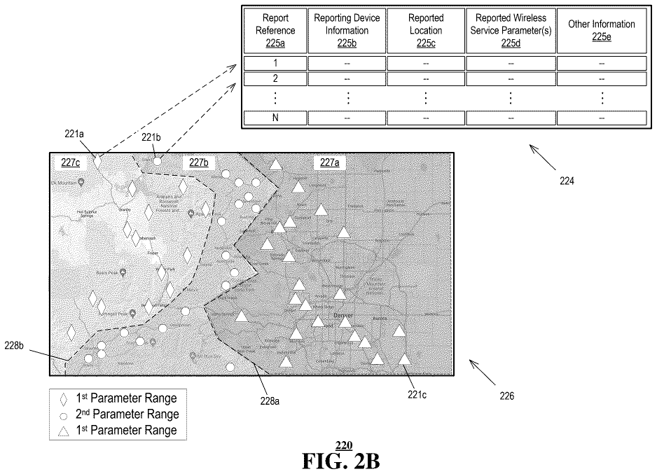

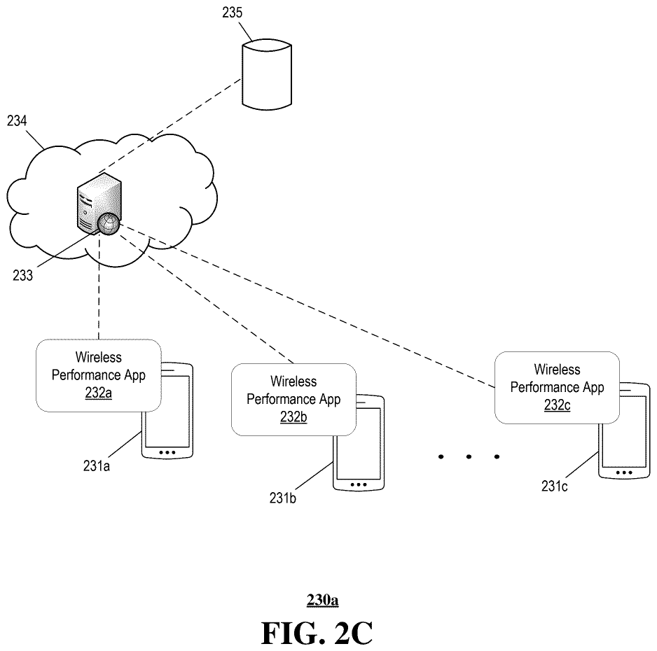

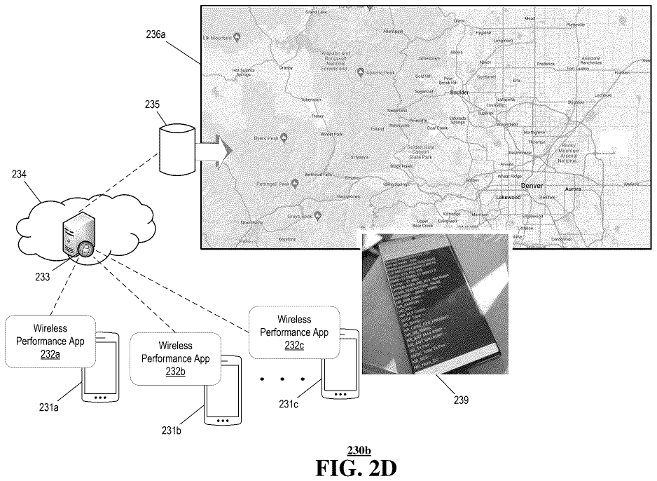

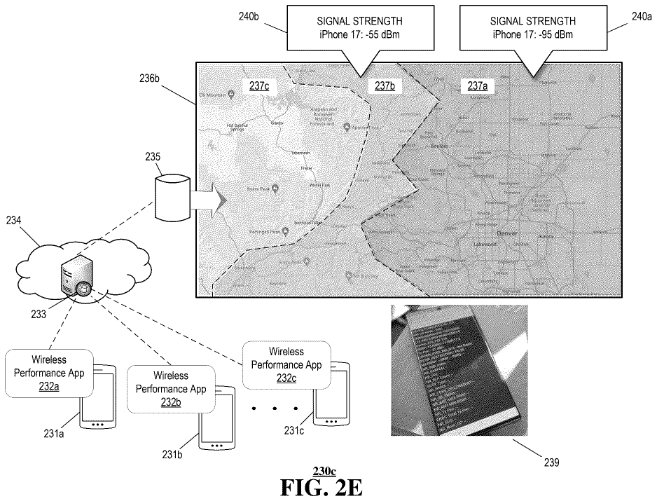

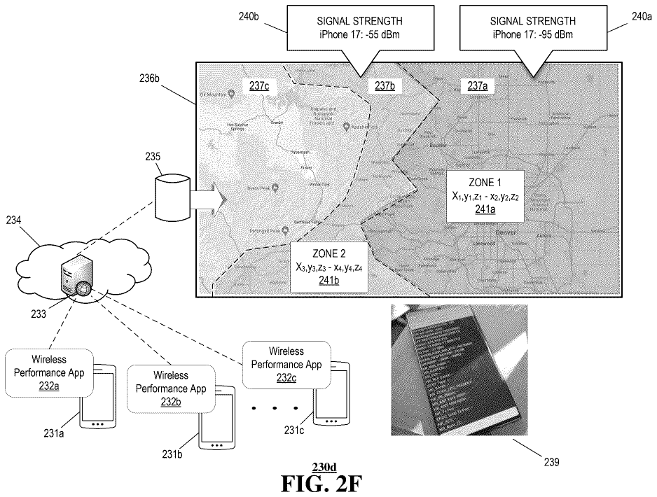

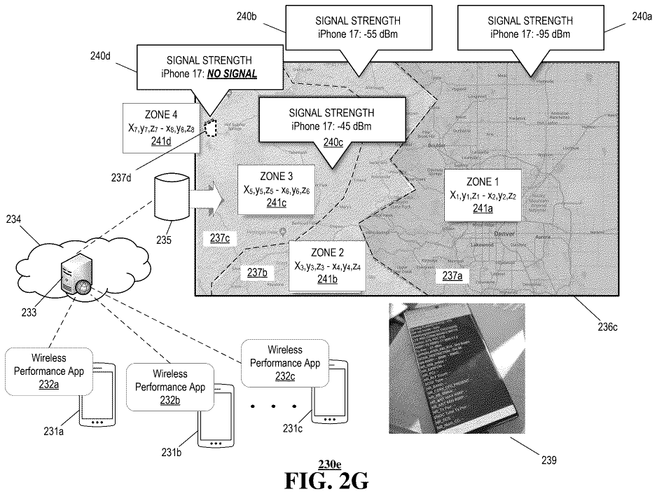

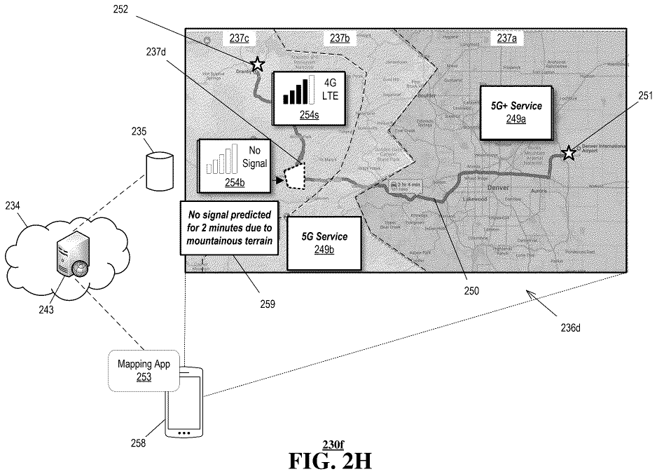

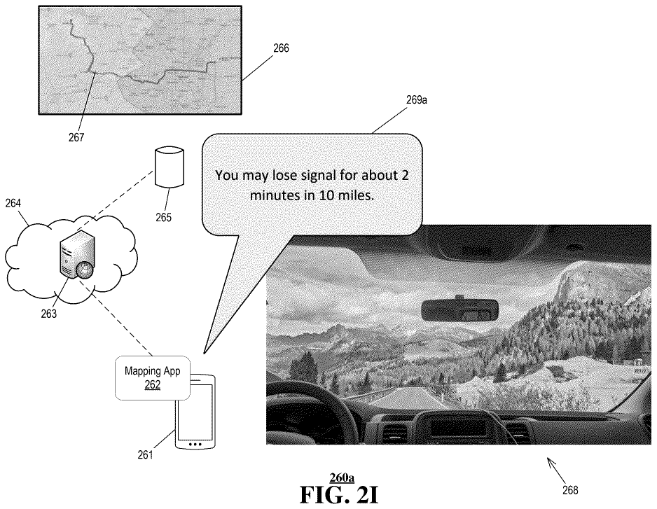

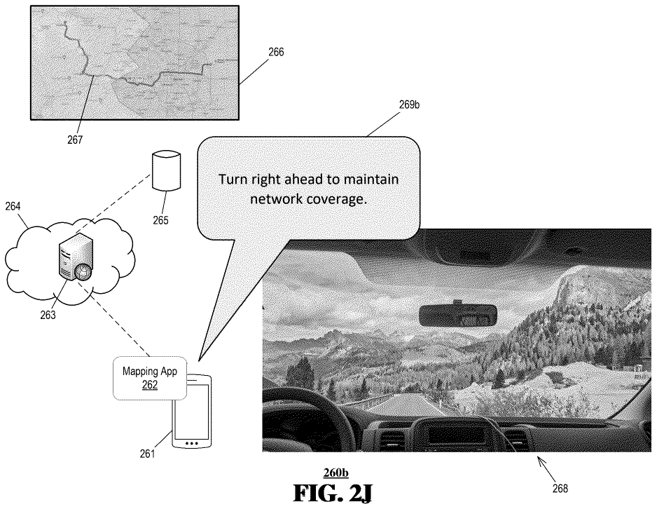

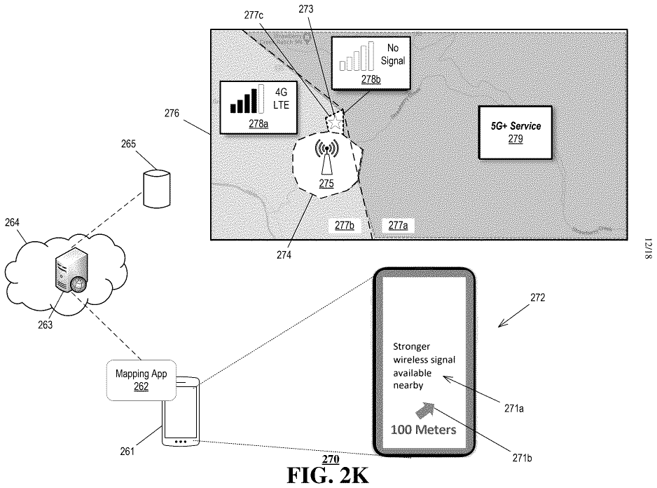

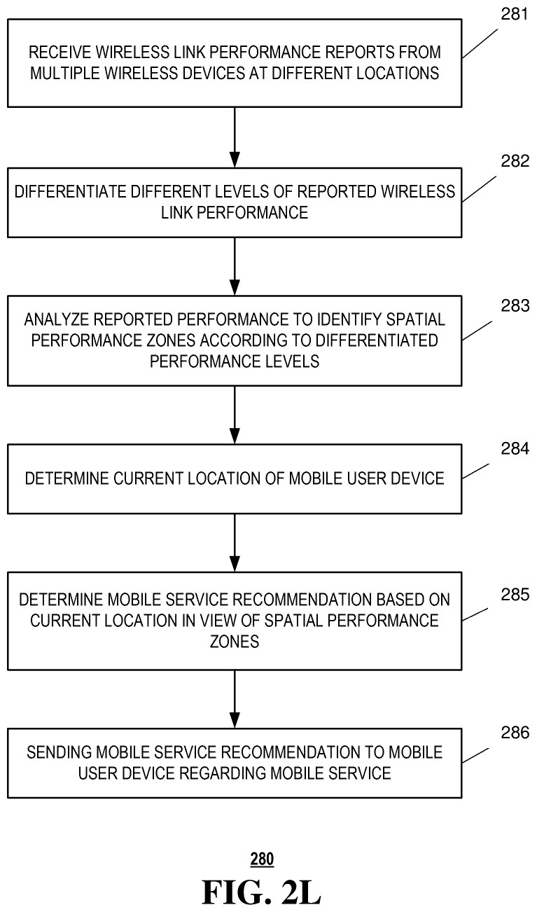

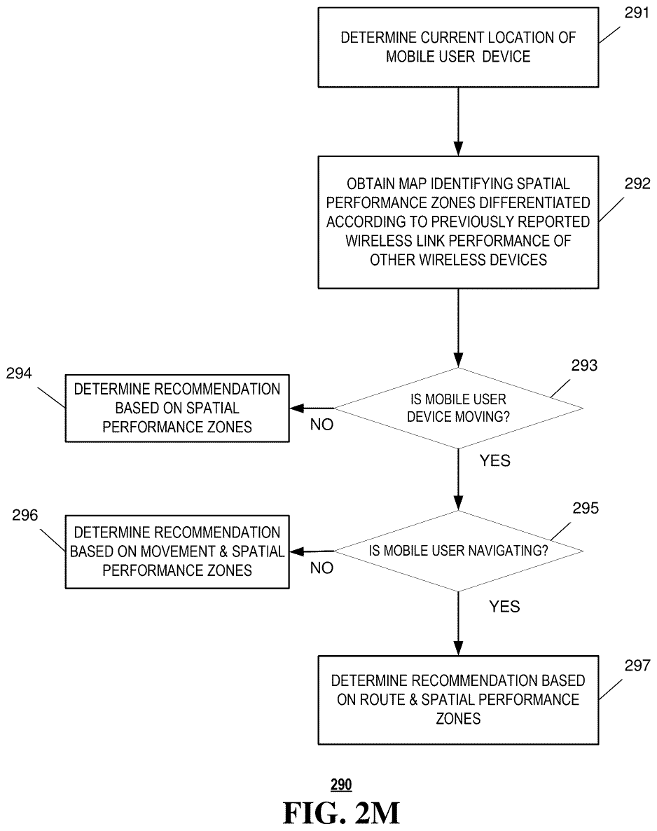

FIG. 2A is a block diagram illustrating an example, non-limiting embodiment of a wireless network performance-based guidance system 200 functioning within the communication system 100 of FIG. 1 in accordance with various aspects described herein. The example wireless network performance-based guidance system 200 can be configured and/or otherwise adapted to provide users with information, including real-time information, about wireless network performance along a travel route 210. The performance-based guidance system 200 includes a wireless communication device 201 equipped with a network performance-based guidance application program 202. This network performance-based guidance application program 202 can interface with a network-performance based guidance processor 203. The example network-performance based guidance processor 203 can be provide at a network node 204 and/or otherwise in communication with the network node 204, e.g., being hosted elsewhere in the network, possibly on a backend server as may be hosted at a datacenter.

The network-performance based guidance processor 203 communicates with a network performance data storage 205, e.g., a database, configured to store wireless network performance data that can include historical and real-time network performance data. This data can be used to generate a wireless network-performance based map 206, which visually represents different wireless coverage regions.

The example network-performance based map 206 includes various differentiated wireless coverage regions, such as a first differentiated wireless coverage region 207a offering 5G+ wireless network service 209a, a second differentiated wireless coverage region 207b providing 5G wireless network service 209b, and a third differentiated wireless coverage region 207c with 4G LTE wireless network service 209c. The map also highlights areas with no wireless network service coverage 213, indicated by a no signal condition 214. It is envisioned that in at least some embodiments, the network-performance based map 206 can be generated based on historical and/or real-time network performance data as reported by wireless devices, base stations and/or access points operating within a geographic area represented in the network-performance based map 206. Alternatively, or in addition, the network-performance based map 206 can be generated, at least in part, based on modeled and/or simulated data as may have been prepared by a mobile network operator for purposes of network planning and/or performance management.

The network-performance based map 206 further delineates network performance regional boundaries, such as a first network performance regional boundary 208a and a second network performance regional boundary 208b. These boundaries 208a, 208b, generally 208, help users understand the transition between different levels of network performance. It is understood that the differentiated wireless coverage regions or zones 207a, 207b, 207c, generally 207, can be based on sampled and/or otherwise reported data.

In some embodiments, at least some of the differentiated wireless coverage regions or zones 207 can be determined at least in part based on a coverage area or region of a cell sector, e.g., including an entire cell sector and/or coverage area and/or possibly multiple cell sectors and/or coverage areas. Alternatively, or in addition, at least some of the differentiated wireless coverage regions or zones 207 can include only a portion of a cell sector and/or coverage area, and/or portions of multiple cell sectors and/or coverage areas. Generally, reference to portions of cell sector(s) and/or coverage area(s) include coverage area(s) or region(s) that are less than entire cell sector(s), e.g., being represented as a percentage and/or a fraction of one or more cell sector(s) or coverage area(s). In at least some embodiments, the differentiated wireless coverage regions or zones 207 are determined without regard to any particular cell sector and/or coverage area. In such instances, it is envisioned that the differentiated wireless coverage regions or zones 207 may happen to include all and/or portions of one or more cell sectors and/or coverage areas.

In some embodiments, at least some of the boundaries 208 between adjacent differentiated wireless coverage regions or zones 207 may be determined according to a cell sector and/or coverage area. For example, a network-performance based map 206 may use cell sectors and/or coverage areas to estimate sizes and/or shapes of the differentiated wireless coverage regions 207 in the absence of network performance samples, and/or to resolve conflicts when reported network performance samples may disagree. It is envisioned that in at least some embodiments, the network-performance based map 206 may be updated and/or improved incrementally, e.g., as more samples of network performance parameters are reported for the region.

The sampled network performance data is associated with sample and/or measurement locations at which a reporting wireless device evaluated and/or otherwise obtained one or more network performance parameters, e.g., signal strength, number of bars, signal quality and the like. It is conceivable that even large numbers of sample points may be grouped and/or otherwise clumped around one or more areas of the region represented in the network-performance based map 206. These areas may correspond to roadways, office buildings, cities, towns, and so on. Likewise, there may be other areas with sparse reporting. Even under such instances, it is advantageous to represent contiguous differentiated wireless coverage regions 207 to provide at least an estimate of coverage in one area based on nearby reported wireless network performance.

It is understood that in at least some embodiments, the boundaries may be determined based on available samples. For example, the boundaries may be determined according to one or more algorithms configured to interpolate at previously unsampled points within the differentiated wireless coverage region according to nearby samples. For example, the samples may be arranged on a grid structure that may align with at least some of the historical samples. Interpolation may be performed to estimate wireless network performance at other grid locations for which there have not yet been reported wireless network performance. The grid may be uniform, e.g., a uniform rectangular grid. Alternatively, or in addition, at least portions of the grid may be non-uniform, e.g., offering different spatial resolutions as may correspond to one or more of available samples and/or other geographic features, e.g., roadways, buildings, towns, cities, and the like. In at least some embodiments, the network performance regional boundaries 208 can be identified according to bounded regions having similar network performance parameters that fall within a predetermined range of parameter values.

It is conceivable that different network-performance based maps 206 may be prepared as described herein for a common geographic mapped region. In such instances the different network-performance based maps 206 can be distinguished according to one or more parameters. In at least some embodiments, the parameters may relate to a type of mobile communication device. In such instances, one different network-performance based map 206 may be presented according to a particular mobile communication device type correspond to a particular mobile user device. Consider one different network-performance based map 206 being presented for iPhone 17 user and a different network-performance based map 206 being presented for an iPhone 13 user. It is envisioned that network performance can rely at least partially upon one or more features of a mobile user device, such as transmit power level, receiver sensitivity level, antenna configurations, device orientation, signal processing capability, and so on. In such instances, a different network-performance based map 206 may be recalled from the wireless network performance data storage 205 based on a determined type of device used by the user navigating according to the illustrative example.

According to the illustrative example, a mobile user is traveling according to a navigation solution that presents travel route 210. The example travel route 210 is plotted on the different network-performance based maps 206, showing the user's journey from a first location, e.g., an origin 211 to a second location, e.g., a destination 212 or waypoint. The wireless network-performance based guidance system 200 can be configured to provide real-time updates and guidance based on the user's current location and the predicted network performance along the route, ensuring optimal connectivity throughout the journey.

FIG. 2B is a schematic diagram illustrating an example, non-limiting embodiment of a wireless network performance reporting scheme 220 of the wireless network-performance based guidance system 200 of FIG. 2A, functioning within the communication system 100 of FIG. 1 in accordance with various aspects described herein. This scheme 200 is designed to collect, analyze, and present wireless network performance data from multiple user devices to create one or more comprehensive wireless network-performance based maps. An example wireless network performance data collection system includes multiple user devices, each equipped with a wireless performance application program configured to monitor and report one or more wireless network performance parameters. These application programs collect various network performance parameters such as signal strength, latency, and bandwidth, and report this data to a network performance database.

The reported data includes a first network parameter reported location 221a, second network parameter reported location 221b, a third network parameter reported location 221c, and so forth up to some number of network parameter reported locations. The locations 221a, 221b, 221c, generally 221, are illustrated on a geographic map. It is understood that in at least some embodiments, the locations may include other information, such as elevations, indications as to whether the location is indoors or out of doors, an indication as to whether the reporting device was stationary or moving, and so on.

The collected data can be processed according to one or more data features to identify different performance zones, which can be visually represented, e.g., as shown on the example wireless network performance-based map 226. For example, the wireless network performance-based map 226 includes a first differentiated wireless coverage region 227a, a second differentiated wireless coverage region 227b and a third differentiated wireless coverage region 227c. These regions are delineated by network performance regional boundaries, such as a first network performance regional boundary 228a and a second network performance regional boundary 228b.

The map 226 visually represents the signal strength for specific devices, such as the iPhone 17, with different colors indicating different levels of performance, e.g., different levels of reported, and thus expected, signal strength, e.g., number of bars. In at least some embodiments, the different levels of performance may correspond to different levels of wireless service. For example, one or more regions of the map 226 may extend differentiated and overlapping wireless services, such as 4G LTE, 5G and 5G+. In at least some embodiments, the regions of the map 226 may correlate to a highest available level of service, e.g., 5G+ over 5G or 4G LTE. Likewise, indicating 5G over 4G LTE, and so on.

In at least some embodiments, the data collected from the wireless devices can be compiled into a wireless network service performance report 224. Without limitation, the wireless network service performance report 224 can include reference values 225a, e.g., to distinguish and/or otherwise establish a sequence of historical reports. Alternatively, or in addition, the wireless network service performance report 224 can include device information 225b of a reporting device, e.g., a make, model, version, orientation, and so on, a reported location 225c, e.g., geocoordinates, one or more reported wireless service parameter(s) 225d, such as signal strength, operating band, signal quality, latency, error rates, and so on. In at least some embodiments, the wireless network service performance report 224 can be configured to capture other information 225c, such as indications as to whether the sample was obtained under indoor or outdoor conditions, under moving or stationary conditions, and so on.

This comprehensive data collection and reporting scheme allows the system to provide real-time guidance and updates to users based on the predicted network performance along their travel routes, ensuring optimal connectivity and user experience.

FIG. 2C is a block diagram illustrating an example, non-limiting embodiment of a wireless network performance reporting system 230a functioning within the communication system 100 of FIG. 1 in accordance with various aspects described herein. According to the illustrative embodiments disclosed herein, multiple users can be equipped with a device such as a smart device that is also equipped with a wireless performance app. The devices are location-aware and periodically communicate their location and device parameters to the wireless performance apps and, in turn, to a network node. The user data reported by the wireless performance apps to the network node may also include timestamp information so that it is understood how long a user is at a location or an area. Additionally, it may also include information about what application is used on the device at specific points in time and where it is used.

The example wireless network performance reporting system 230a can be configured to collect and analyze wireless network performance data from multiple wireless devices. The wireless devices can include mobile user devices, e.g., mobile phones, tablet devices, smart watches, laptops, and the like. Alternatively, or in addition, the wireless devices can include stationary devices, e.g., roadway sensors, Internet connected devices, e.g., according to the IoT, and so on. This example wireless network performance reporting system 230a is integral to providing users with real-time guidance based on historical and current network performance data.

Generally, the example wireless network performance reporting system 230a obtains samples from multiple wireless communication devices 231a, 231b, 231c, generally 231. In at least some embodiments, at least some of the wireless communication devices 231 are equipped with a wireless performance apps 232a, 232b, 232c, generally 232. These apps 232 are responsible for collecting various network performance parameters such as signal strength, latency, and bandwidth. The collected data can then be transmitted to a network performance data collector 233 via a network 234. It is understood that in at least some embodiments the reported information can be obtained by queries initiated by the network performance data collector 233. Alternatively, or in addition, the wireless communication devices 231, e.g., by way of the apps 232 may be configured to push the sample data to the network performance data collector 233. In at least some embodiments, the wireless communication devices 231, e.g., by way of the apps 232, may be configured to acquire samples of the network performance parameters and associated geographic locations and to locally store the sampled data until requested by the network performance data controller 233 and/or until such convenient time at which the data may be provided, e.g., pushed, to the network performance data collector 233.

The network performance data collector 233 can be configured to aggregate sampled data from all the wireless communication devices 231 and forwards it to a network performance database 235. This database stores historical and/or real-time wireless network performance data, which can be used to generate comprehensive performance maps and reports as discussed herein.

In at least some embodiments, the wireless performance apps 232a, 232b, 232c can be configured to operate in the background on the wireless communication devices 231, e.g., periodically collecting and reporting data without requiring user intervention. Such continuous data collection allows the wireless network performance reporting system 230a to maintain an up-to-date view of network performance across different geographic regions and device types. To the extent sample and/or reporting schedules are discussed herein, it is understood that the schedules can be configured according to a regular reporting interval, e.g., based on a time duration of seconds, minutes, hours, hours, days, weeks, and so on. In some embodiments, the sample and reporting periods are the same. Alternatively, or in addition, the sample and reportion periods differ, e.g., with the samples obtained according to a relatively short sample period, while the reporting can be provided at a relatively long periods.

In at least some embodiments, one or more of the sample time and/or reporting time may be determined according to an event. Events can include, without limitation, a location of the mobile user device occurring within a predetermined region, an attachment of a mobile device to a wireless network, activation and/or deactivation of a mobile application program, a mobility state of the mobile device, e.g., reporting according to a first reporting period while moving and a second reporting period while stationary.

In at least some embodiments, the network performance data collector 233 can adjust reporting according to historical reporting records. For example, the network performance data collector 233 may identify some regions as having ample and substantially current network performance reports, while other regions have inadequate and/or outdated network performance reports. In such instances, the network performance data collector 233 may impose a reporting schedule configured to promote greater and/or more frequent reporting in an underreported area, while imposing a less stringent reporting schedule in those areas with sufficient reporting.

In at least some embodiments, the network performance database 235 can serve as a central repository for all collected data, enabling the system to analyze trends, identify performance zones, and predict future network performance. This information is crucial for providing users with accurate and timely guidance on network performance along their travel routes.

In summary, FIG. 2C depicts the architecture of the wireless network performance reporting system 230a, highlighting the interaction between user devices, the network performance data collector, and the network performance database. This system ensures that users have access to reliable and comprehensive network performance data, enhancing their connectivity experience.

FIG. 2D is a block diagram illustrating in further detail an example, non-limiting embodiment of a wireless network performance reporting system 230b, functioning within the communication system 100 of FIG. 1 in accordance with various aspects described herein. The example wireless network performance reporting system 230b is designed to collect, analyze, and present wireless network performance data from multiple user devices to create a comprehensive performance map.

According to the illustrative embodiments, over a period of time, the devices use the wireless performance apps to collect and report data describing the wireless performance for the user devices to a network performance database. The apps send to the network node and network performance database data parameters that describe the configuration and usage of the wireless devices at various points in time and various locations, which may include, among other data, the model and version of the devices, the version of the operating system of the devices, bandwidth data, signal strength, latency data, and band and antenna data for data connections over the period of time. Also, location and timestamp data can be reported. This data may be collected by the apps in the background and need not be presented visually to the user as shown in the illustrative example.

The system includes multiple wireless communication devices 231, each equipped with a wireless performance app 232. These apps 232 collect various network performance parameters such as signal strength, latency, and bandwidth, and report this data to the network performance database 235 via the network performance data collector 233. The network performance database 235 aggregates the data from all the wireless communication devices 231 and processes it to identify different performance zones. This data can then be associated with a map 236a, e.g., according to an overlay, to generate the wireless network performance-based map 226 (FIG. 2B), which visually represents different wireless coverage regions. The map includes various differentiated wireless coverage regions, such as regions with strong signal strength and regions with weak or no signal coverage.

The wireless performance apps 232 can operate in the background on the wireless communication devices 231, periodically collecting and reporting data without requiring user intervention. This continuous data collection allows the system to maintain an up-to-date view of network performance across different geographic regions and device types. The wireless performance apps 232 can present network performance content on user interface, e.g., a display 239 on the wireless communication device 231. The example display 239 shows real-time updates and guidance based on the user's current location and the predicted network performance along their travel route. For example, the display 239 reflects example data shown for one device make and model number as may be provided to ensure optimal connectivity throughout a journey.

In summary, FIG. 2D depicts the architecture of the wireless network performance-based guidance system 230b, highlighting the interaction between user devices, the network performance data collector, and the network performance database. This system ensures that users have access to reliable and comprehensive network performance data, enhancing their connectivity experience.

FIG. 2E is a block diagram illustrating in still further detail an example, non-limiting embodiment of a wireless network performance reporting system 230c, functioning within the communication system 100 of FIG. 1 in accordance with various aspects described herein.

According to the illustrative embodiments, collective wireless performance data may be processed by a network node and network performance database to create a set of data representing geographic coordinates that are contiguous that reflect similar levels of wireless performance parameters across the devices. These contiguous data may be represented as wireless performance zones and reflect one or more conditions, such as wireless device, model, and version, in the example shown. It is noted that the example representations offer a broad view of performance zones. In practice, the detail of performance zone definition can be much more granular. As additional wireless performance app data is collected, performance zones may be defined to identify location conditions such as weaker signal strengths due to geographic or created landscapes such as mountains or urban canyons, as well as pockets of weaker coverage caused due to tower placements or capabilities and indoor vs. outdoor cell signal strengths.

The example wireless network performance reporting system 230c generates a wireless network performance-based map 236b based on data stored in the network performance database 235 as obtained from the example wireless communication devices 231. The wireless network-performance based map 236b visually represents different wireless coverage regions. For example, the wireless network-performance based map 236b includes a first differentiated wireless coverage regions 237a associated with a relatively good performance such that a relatively weak signal is sufficient, as indicated by the first region summary network, performance information 240b, which indicates a relatively low uplink signal strength of −95 dBm in association with a particular type of device, e.g., an iPhone 17. Likewise, the wireless network-performance based map 236b includes a second differentiated wireless coverage regions 237b associated with a relatively poorer performance such that a relatively stronger uplink signal is required, as indicated by the first region summary network, performance information 240b, which indicates an uplink signal strength of −55 dBm in association with the same type of device.

FIG. 2F is a block diagram illustrating in still further detail an example, non-limiting embodiment of a wireless network performance reporting system 230d, functioning within the communication system 100 of FIG. 1 in accordance with various aspects described herein.

The wireless network performance based map 236b includes various differentiated wireless coverage regions, such as those regions 237a, 237b, 237c, generally 237, presented in the previous figures. These regions 237 can be delineated by network performance regional zones. For example, a first differentiated coverage regional zone, i.e., Zone 1, can be identified by a first boundary delimiter 241a. Without limitation, the first boundary delimiter may include one or more coordinates and/or lines that identify an extent of Zone 1. Likewise, a second differentiated coverage regional zone, i.e., Zone 2, can be identified by a second boundary delimiter 241b. Once again, without limitation, the second boundary delimiter may include one or more coordinates and/or lines that identify an extent of Zone 2. The boundary delimiters 241a, 241b can be used to identify and/or otherwise distinguish the different zones on the wireless network performance based map 236b. It is understood that the numbers, size, shape and/or extent of the zones may vary over time as more data samples are obtained and/or as network conditions change, e.g., according to structural changes.

Since location data may be collected on user devices in three dimensions, the performance zones may be defined by geographic sets of points or geographic ranges of points, as shown. Again, the performance zones may be identified and defined by the network performance database by comparing similar performance characteristics of the user data collected within contiguous locations within three dimensions. There may be large numbers of zones with very high granularity based on the degree of location specificity. The level of specificity of the performance zones created by the network performance database may also be adjusted by tuning the level of specificity of the performance parameters analyzed. For example, a higher or lower signal strength range may be made to be broad, or very narrow based on the needs of the business.

FIG. 2G is a block diagram illustrating in still further detail an example, non-limiting embodiment of a wireless network performance reporting system 230e, functioning within the communication system 100 of FIG. 1 in accordance with various aspects described herein. According to the illustrative example, the wireless performance apps 232 may also have the capability to collect location data when they are not connected to a network 234 since the location information may be determined locally on the device 231, such as via a GPS satellite connection. For example, when the devices 231 are unable to connect to a network, they may periodically collect location information during that time and then later, when they are able to connect to a network, report the points of location that they detected when they were unable to connect to the network. These location data points may be reported as a “no signal zone,” such as is shown in zone 4 241d in the figure.

An updated wireless network performance-based map 236c obtained by the wireless network performance reporting system 230e identifies four distinguishable zones or differentiated regions 237a, 237b, 237c, 237d, generally 237. Each differentiated region 237 is illustrated as having associated regional summary network performance information 240a, 240b, 240c, 240d, generally 240.

If it is predicted, based on a previous users' network performance data, that there is a segment of the planned route that will experience no signal, a notification may be displayed accordingly, as shown. According to the illustrative example, a fourth differentiated region 237d relates to a region within which no wireless service is available. In such instances, it may be impractical and/or otherwise impossible for a reporting wireless device to provide updated wireless network performance report indicating no coverage, while operating within the no-coverage region. In such instances, the wireless performance app 232 may continue to obtain samples, storing the samples until they can be relayed at a later time, e.g., when wireless service has been reestablished, to the network performance data collector 233.

FIG. 2H is a block diagram illustrating an example, non-limiting embodiment of a wireless network performance-based guidance system 230f according to an example operational scenario, functioning within the communication system 100 of FIG. 1 in accordance with various aspects described herein. The wireless network performance-based guidance system 230f is designed to provide users with information, e.g., status and/or guidance information, about wireless network performance along a travel route as may have been obtained according to a navigation solution.

In at least some embodiments, at a later time, another user may use a mapping application to plan, for example, a driving route. The mapping application may access the network performance database 235 to retrieve the performance data that was created and stored there, including its location, specific data, to overlay a presentation of historical collected network performance data for the specific device type that the user is using.

The wireless network performance-based guidance system 230f includes a mobile communication device 258, such as an iPhone 17, equipped with a wireless network performance-based guidance app 253. This app 253 interfaces with a network performance database 235 via a network node 234. The network performance database 235 stores historical and real-time wireless network performance data collected by a network performance data collector 233 (FIG. 2G).

In at least some embodiments, the wireless network performance-based guidance app 253 on the mobile communication device 258 accesses the network performance database 235 to retrieve relevant data. This data can be used to generate the example wireless network performance-based guidance map 236d, which visually represents different wireless coverage regions along the user's travel route 250 between an origin 251 and a destination 252 or waypoint.

The wireless network performance-based guidance map 236d includes various differentiated wireless coverage regions, such as a first differentiated wireless coverage region 237a offering 5G+ wireless network service 249a, a second differentiated wireless coverage region 237b providing 5G wireless network service 249b, a third differentiated wireless coverage region 237c with 4G LTE wireless network service 254a, and a fourth differentiated wireless coverage region 237d corresponding to a no-wireless-network-service coverage region, as may have been indicated by a reported no signal condition 254b.

For example, data from the network performance database 265 that was created by the collection of performance data from past users may be used to provide notifications to a user who is traveling along a route. This may be a preplanned route or not necessarily needs to be. As the wireless performance app monitors the current location of the user device, it may anticipate that the device is entering a zone that will result in a change in the predicted network performance for the user. This can be based on an analysis of the mapping data, the direction that the user is traveling, and the stored network performance data and performance zone information. The level of notification information presented may be adjustable, such that the user is notified only in the case of certain predicted performance changes, such as when it is expected that no signal conditions may exist.

For example, in at least some embodiments, the wireless network performance-based guidance system 230f provides real-time updates and guidance based on the user's current location and the network performance along the route as determined according to the wireless network performance-based guidance map 236d. For instance, the map includes a notification indicating “No signal predicted for 2 minutes due to mountainous terrain,” helping the user anticipate connectivity issues.

The mobile-network-service information element 259 provides additional details about the network performance, ensuring that the user is well-informed about the expected connectivity along their travel route.

In summary, FIG. 2H depicts the architecture and functionality of the wireless network performance-based guidance system 230f, highlighting the interaction between the mobile communication device, the wireless network performance-based guidance app, the network performance data collector, and the network performance database. This system ensures that users have access to reliable and comprehensive network performance data, enhancing their connectivity experience during travel.

FIG. 2I is a block diagram illustrating an example, non-limiting embodiment of a wireless network performance-based guidance system 260a according to another example operational scenario, functioning within the communication system 100 of FIG. 1 in accordance with various aspects described herein. The example wireless network performance-based guidance system 260a is designed to provide users with information about wireless network performance along a travel route, ensuring optimal connectivity and user experience.

The wireless network performance-based guidance system 260a includes a mobile communication device 261, such as a smartphone, equipped with a wireless network performance-based guidance app 262. This app 262 interfaces with a network performance-based guidance processor 263 connected to a network 264. The network 264 communicates with a wireless network performance data storage 265 that stores wireless network performance data based at least in part upon historical network performance measurements. In at least some embodiments, the stored wireless network performance data includes individual sampled data records, e.g., as shown in the wireless network service performance report 224 (FIG. 2B). Alternatively, or in addition, the stored wireless network performance data includes one or more wireless network performance based maps 226.

In at least some embodiments, the wireless network performance-based guidance app 262 on the mobile communication device 261 can be configured to accesses the wireless network performance data storage 265 to retrieve relevant data. In at least some embodiments, relevancy is determined according to a current and/or future location of the mobile communication device 261. Alternatively, or in addition, the relevancy is determined according to device related information of the mobile communication device, e.g., a device make, model, version, and so on. This data can be used to generate a wireless network performance-based guidance map 266 locally, e.g., via the wireless network performance-based guidance app 262, which visually represents different wireless coverage regions along the user's travel route 267. Alternatively, or in addition, the data can be used to generate the wireless network performance-based guidance map 266 at the network performance-based guidance processor 263. In at least some embodiments, the wireless network performance-based guidance map 266 can be updated periodically and stored at the wireless network performance data storage 265

According to the illustrative example, the travel route 267 can be plotted on the map 266, showing the user's journey through various geographic regions. The plotting can be performed by the wireless network performance-based app 262, the network performance-based guidance processor 263 or a combination thereof. The wireless network performance-based guidance system 260a can provide periodic, e.g., real-time, updates and guidance based on the user's current location and the predicted network performance along the route 267. For instance, the wireless network performance-based guidance system 260a includes a mobile-network-service informational advisory 269a indicating “You may lose signal for about 2 minutes in 10 miles,” helping the user anticipate connectivity issues.

The traveler's view 268 is depicted to show the real-world scenario where the user is traveling through a mountainous terrain, which may affect the wireless network signal. The mobile-network-service informational advisory 269a can be displayed on the mobile communication device 261, providing the user with timely and relevant information about potential signal loss. Alternatively, or in addition, the informational advisory 269a may be presented as an audible alert and/or message.

In summary, FIG. 2I depicts the architecture and functionality of the wireless network performance-based guidance system 260a, highlighting the interaction between the mobile communication device, the wireless network performance-based guidance app, the network performance-based guidance processor, the network, and the wireless network performance data storage. This system ensures that users have access to reliable and comprehensive network performance data, enhancing their connectivity experience during travel.

FIG. 2J is a block diagram illustrating an example, non-limiting embodiment of a wireless network performance-based guidance system 260b according to yet another example operational scenario, functioning within the communication system 100 of FIG. 1 in accordance with various aspects described herein. For example, based on the determination of predicted upcoming loss or degradation of wireless network performance in an area, the wireless performance app may access mapping data to determine alternate routes that would provide improved network performance. An alternative route may be presented to the user, and they may accept it, for example, based on an anticipated change in an estimated time of arrival or deviation from an expected plan.

As in the previous example, the user's travel route 267 can be plotted on the map 266, showing the user's journey through the various geographic regions. The wireless network performance-based guidance system 260b can provides periodic and, in at least some instances, real-time updates and guidance based on the user's current location and the predicted network performance along the route. For instance, the system includes a mobile-network-service informational recommendation 269b indicating “Turn right ahead to maintain network coverage,” helping the user make informed decisions to avoid areas with poor connectivity. This message offers an alternative to the user's current travel route 267 based on the wireless network performance-based map 266.

Once again, the traveler's view 268 is depicted to show the real-world scenario where the user is traveling through a mountainous terrain, which may affect the wireless network signal. The mobile-network-service informational recommendation 269b can be displayed on the mobile communication device 261, providing the user with timely and relevant information about potential signal loss and suggesting an alternate route to maintain network coverage. Alternatively, or in addition, the informational advisory 269a may be presented as an audible alert and/or message.

In summary, FIG. 2J depicts the architecture and functionality of the wireless network performance-based guidance system 260b, highlighting the interaction between the mobile communication device, the wireless network performance-based guidance app, the network performance-based guidance processor, the network, and the wireless network performance data storage. This system ensures that users have access to reliable and comprehensive network performance data, enhancing their connectivity experience during travel.

FIG. 2K is a block diagram illustrating an example, non-limiting embodiment of a wireless network performance-based guidance system 270 according to an example operational scenario, functioning within the communication system 100 of FIG. 1 in accordance with various aspects described herein. This wireless network performance-based guidance system 270 is designed to provide users with timely information about wireless network performance and guide them to areas with optimal connectivity.

In yet another embodiment, the network performance data that was collected initially may include connections to Wi-Fi networks, in particular, publicly available networks. The wireless performance app may detect that the user is in a location that is not currently receiving a network signal or is receiving a weak signal. In this case, the wireless performance app may access network performance data to identify the nearest location to the user's current location that has improved wireless signal performance. This improved performance may be from a Wi-Fi network or other network. The wireless performance app may offer the user directions to the nearest improved network performance location for their particular device and configuration parameters.

The example wireless network performance-based guidance map 276 includes various differentiated wireless coverage regions, such as a first differentiated wireless coverage region 277a offering 4G LTE wireless network service, a second differentiated wireless coverage region 277b providing 5G+ wireless network service, and a no-coverage region 277c, indicated by a reported no signal condition 278b.

In at least some embodiments, the example wireless network performance-based guidance system 270 is configured to identify alternate wireless service coverage regions 274. For example, the wireless network performance-based guidance map 276 can be configured to identify the alternate service coverage region 274 supported by alternate service coverage equipment 275, e.g., a Wi-Fi access point. It can be appreciated that the alternate service coverage region 274 can provide improved network performance, particularly in regions having reduced, compromised and/or no coverage.

Continuing with the illustrative example, the mobile user is positioned at a location 273 determined to provide no-coverage, i.e., a no-coverage region, according to a previously generated wireless network performance-based guidance map 276. In at least some embodiments, the wireless network performance-based app 262 and/or the network performance-based guidance processor 263 can be configured to identify such compromised and/or no coverage regions 274, and in response, to identify the availability of nearby alternate service coverage regions 274 that may provide overlapping coverage to the user's current position, and/or serve as a viable opportunity being nearby and otherwise easily accessible to the user.

It is envisioned that the mobile communication device may experiences a lack of network signal at a position and/or within a region that may not yet be accounted for in the wireless network performance-based guidance map 276, or perhaps may have been incorrectly estimated to have coverage, e.g., according to an interpolation solution arriving at the differentiated coverage regions 277a, 277b. In at least some embodiments, the mobile communication device 261 notifies the network performance-based guidance processor, which may, in response, determine if a viable alternate service coverage region 274 may exist nearby. The mobile-network-service app display 272 on the mobile communication device 261 may be configured to provide real-time updates and guidance based on the user's current location and the predicted network performance along the route. For instance, the mobile-network-service informational element 271a indicates “Stronger wireless signal available nearby,” and the mobile-network-service guidance element 271b provides directions to the nearest location with improved network performance, such as “100 Meters.” Alternatively, or in addition, the mobile-network-service informational element 271a may indicate “an alternative service coverage region, e.g., Wi-Fi, is available nearby.”

The traveler's view 268 is depicted to show the real-world scenario where the user is traveling through an area with varying network performance. The system provides timely and relevant information about potential signal loss and suggests alternate routes or locations to maintain network coverage.

In summary, FIG. 2K depicts the architecture and functionality of the wireless network performance-based guidance system 270, highlighting the interaction between the mobile communication device, the wireless network performance-based guidance app, the network performance-based guidance processor, the network, and the wireless network performance data storage. This system ensures that users have access to reliable and comprehensive network performance data, enhancing their connectivity experience during travel.

FIG. 2L depicts an illustrative embodiment of a wireless network performance-based guidance process 280 in accordance with various aspects described herein. The example wireless network performance-based guidance process 280 can be designed to provide users with real-time recommendations based on wireless network performance data collected from multiple wireless devices at different locations, including historical network performance data. This wireless network performance-based guidance process 280 can ensure reliable and, in at least some instances, optimal connectivity and user experience by guiding users to areas with better network performance.

The wireless network performance-based guidance process 280 includes receiving, at 281, wireless link performance reports from multiple wireless devices at different locations. The system receives performance data from multiple wireless devices, such as smartphones, equipped with wireless performance apps. These devices periodically report various network performance parameters, including one or more of signal strength, latency, bandwidth, number of bars, attached wireless service, application program, to a network performance database. This step can be similar to the data collection described elsewhere herein, e.g., in relation to FIGS. 2C, 2D, 2E, 2F, and 2G, where wireless devices continuously collect and report network performance data.

The wireless network performance-based guidance process 280 further includes differentiating, at 282, different levels of reported wireless link performance. The system can be configured to differentiate the collected performance data into various performance levels or ranges, e.g., a predetermined number of ranges between some minimum and maximum value. In at least some embodiments, the ranges correspond to numbers of bars as may be reported on a user interface of a mobile user device, e.g., with different regions for no bars, 1 bar, 2 bars, 3 bars, 4 bars, and 5 bars. Other differentiated regions may include fewer differentiated ranges, e.g., distinguishing poor coverage, e.g., below 2 or 3 bars, from adequate coverage, e.g., above 3 or 4 bars. This differentiation can help in categorizing the data based on signal strength, quality, and other relevant parameters. This step aligns with the differentiation of network performance data into multiple performance ranges as described in FIGS. 2E, 2F, and 2G.

Continuing with the example wireless network performance-based guidance process 280, reported performance parameters are analyzed, at 293, to identify spatial performance zones according to differentiated performance levels. The system can be configured to analyze the differentiated performance data to identify spatial performance zones. For example, the sampled data values can be assigned to identified ranges and overlayed on a map. In at least some embodiments, the map may be subdivided into the performance zones according to the observed samples. These zones represent geographic areas with similar network performance characteristics. It is envisioned that the spatial performance zones may be determined according to differing granularities, e.g., spatial granularities, as may be permissible in view of available numbers and/or values of reported performance parameters. In at least some embodiments different zones may be established over the same region, e.g., over a mapped region, based on other information, such as a device type, weather conditions, mobility information, e.g., speed, acceleration and/or directions of the reporting wireless devices and so on. This analysis is similar to the creation of performance zones depicted in FIGS. 2D, 2E, 2F, and 2G, where the system generates maps showing different wireless coverage regions based on the collected data.

A current location of the mobile user device is determined at 284. The system can be configured to determine a current location of the mobile user device. In at least some embodiments, this step can involve using location data obtained and/or otherwise reported from the user's device, such as GPS coordinates, to pinpoint the device's position. Alternatively, or in addition, the system may be configured to determine a current location of the mobile user device based on network obtained information including one or more of measured uplink signal level, reported downlink signal level, angle of arrival and/or time difference of arrival of wireless signal exchanges between the mobile user device and network equipment, e.g., one or more base stations or access terminals 122 (FIG. 1). This can be akin to the location determination described in FIGS. 2H, 2I, and 2J, where the system uses the user's current location to provide real-time updates and guidance.

According to the illustrative example, a mobile service recommendation is determined at 285 based on current location in view of the spatial performance zones. The system can be configured to determine a mobile service recommendation based on the user's current location and the identified spatial performance zones. This recommendation may include guidance on the best route to maintain optimal network connectivity or suggestions for alternative locations with better network performance. This step is similar to the guidance provided in FIGS. 2H, 2I, and 2J, where the system offers real-time recommendations to users based on predicted network performance.

Still further, according to the example wireless network performance-based guidance process 280, a mobile service recommendation is sent, at 286, to the mobile user device regarding a mobile service. The system sends the mobile service recommendation to the user's device. This recommendation can be displayed on a user interface of the device, providing the user with actionable information to enhance their connectivity experience. Alternatively, or in addition, the recommendation can be an audible presentation as in an alarm and/or spoken message. This step aligns with the real-time updates and guidance shown in FIGS. 2H, 2I, and 2J, where the system communicates performance-based information to the user's device.

In summary, the example wireless network performance-based guidance process 280 provides a comprehensive process for collecting, analyzing, and utilizing wireless network performance data to provide users with real-time recommendations. This process ensures that users have access to reliable and comprehensive network performance data, enhancing their connectivity experience during travel. The steps in FIG. 2L are closely related to the data collection, analysis, and guidance mechanisms described in FIGS. 2C through 2J.

FIG. 2M illustrates an example, non-limiting embodiment of a wireless network performance-based guidance process 290, which is designed to provide users with real-time recommendations based on wireless network performance data collected from multiple wireless devices at different locations. This process ensures reliable and, in at least some instances, optimal connectivity and user experience by guiding users to areas with better network performance.

The example wireless network performance-based guidance process 290 includes determining, at 291, a current location of a mobile user device. The system can be configured to determine the current location of the mobile user device. This step can involve using location data from the user's device, such as GPS coordinates, and/or network provider information, to pinpoint the device's position. This is similar to the location determination described in FIGS. 2H, 2I, and 2J, where the system uses the user's current location to provide real-time updates and guidance.

According to the wireless network performance-based guidance process 290, a map is obtained at 292 identifying spatial performance zones differentiated according to previously reported wireless link performance of other wireless devices. For example, the system can be configured to retrieve a map that identifies spatial performance zones based on previously reported wireless link performance data from other wireless devices. In at least some embodiments, the map visually represents different wireless coverage regions and their performance characteristics, similar to the maps described in FIGS. 2D, 2E, 2F, and 2G.

Further according to the example wireless network performance-based guidance process 290, the system checks, at 293, whether the mobile user device is moving. In at least some embodiments, this decision point can determine the subsequent steps in the process 290. For example, to the extent that it is determined at 293 that the mobile user device is not moving, the system, at 294, determines a recommendation based on the spatial performance zones. This recommendation may include guidance on a best location to maintain optimal network connectivity. If, however, it is determined at 293 that the mobile user device is moving, the system, at 295, next determined whether the moving user is navigating, e.g., traveling according to a planned route between an origin and a destination or waypoint.

To the extent it is determined, at 296, that the mobile user is moving but not navigating, the system can be configured to determine a recommendation, at 296, based on both the movement of the device and the spatial performance zones. This recommendation may include guidance as to a best route to maintain reliable and/or optimal network connectivity while moving. To the extent it is determined, at 296, that the mobile user is also navigating, the system can be configured to determine, at 297, a recommendation based on the planned route and the spatial performance zones. This recommendation may include guidance on the best route to maintain a reliable and/or optimal network connectivity throughout the journey, similar to the route planning and guidance described in FIGS. 2H, 2I, and 2J.

In summary, the example wireless network performance-based guidance process 290 provides a comprehensive process for collecting, analyzing, and utilizing wireless network performance data to provide users with real-time recommendations. This process ensures that users have access to reliable and comprehensive network performance data, enhancing their connectivity experience during travel. The steps in FIG. 2M are closely related to the data collection, analysis, and guidance mechanisms described in FIGS. 2C through 2J.

While for purposes of simplicity of explanation, the respective processes are shown and described as a series of blocks in FIGS. 2L and 2M, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

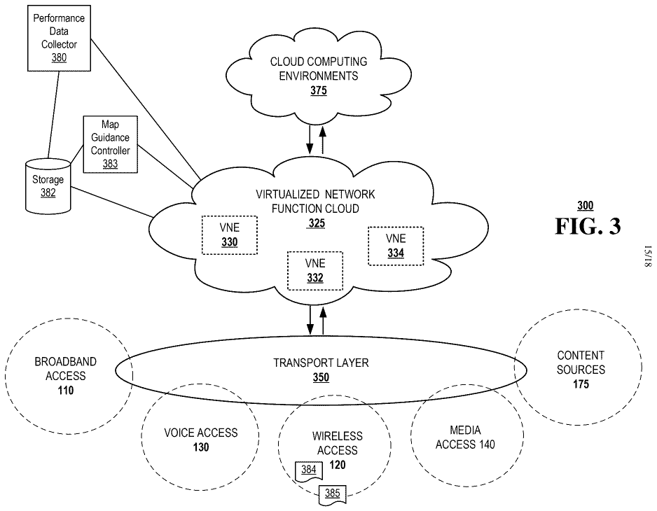

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of the communication system 100, the subsystems and functions of system 200, and method 230 presented in FIGS. 1, 2A, 2B, 2C, and 3. For example, virtualized communication network 300 can facilitate in whole or in part receiving performance data from multiple wireless communication devices at various locations describing wireless network performance at their respective locations, analyzing the data to identify one or more performance zones and providing guidance and/or recommendations to a mobile user device based on the performance zones proximate to the mobile user device. In at least some embodiments, the collected information can include other information, such as device type information and/or application usage in association with the performance data. Guidance and/or recommendations can include, without limitation, advisories, e.g., warning of nearby performance degradations and/or outages, navigation information, e.g., recommended alternate routes based on current and/or planned mobile services and/or advertisements of nearby alternative wireless services, e.g., Wi-Fi hotspots.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. At other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

The example virtualized communication network 300 can include and/or otherwise support operation of one or more of a performance data collector 380, a performance data store 382 and, in at least some embodiments, a mapping guidance module 383. The performance data collector 380 can be operable to collect data associated with multiple wireless devices, including wireless performance data, and to generate a historical record based on the collected data. In at least some embodiments, mobile devices via the wireless access 120 can be configured with one or more of a mobile wireless performance data monitoring application program (app) 384 or a mobile guided positioning app 355. The mobile apps 384, 385 can be configured according to other mobile apps described herein, e.g., the mobile wireless performance data monitoring app 184 and/or the mobile guided positioning app 185 (FIG. 1).

It is understood that one or more of the performance data collector 380, the performance data store 382 and/or the mapping guidance module 383 may be hosted in whole or in part at one or more of the example VNEs 330, 332, 334 and/or distributed across multiple VNEs 330, 332, 334. Alternatively, or in addition, one or more of the performance data collectors 380, the performance data store 382 and/or the mapping guidance module 383 may be hosted in whole or in part in the example cloud computing environment 375, e.g., as may be hosted at one or more data centers.

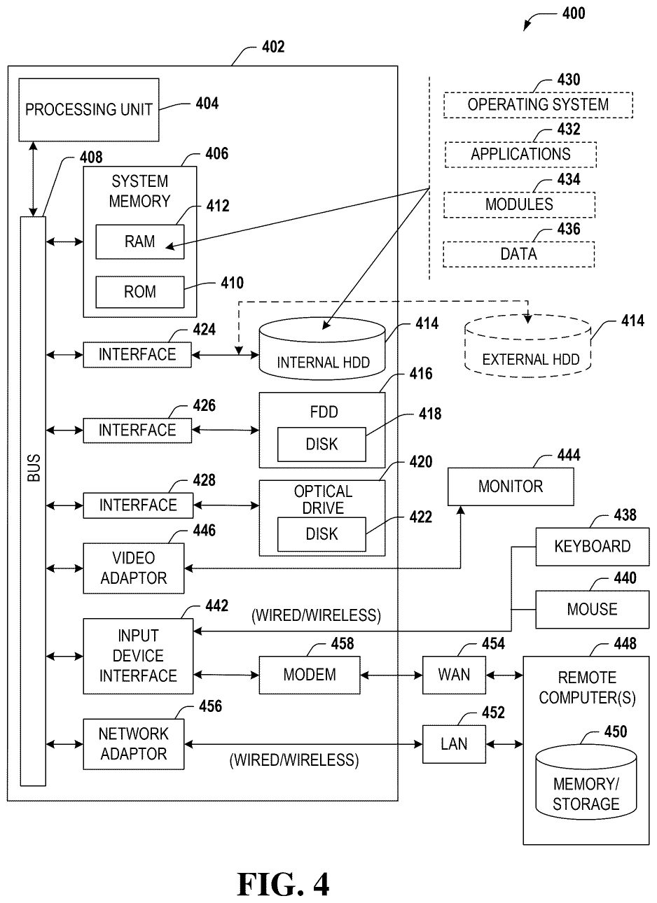

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving performance data from multiple wireless communication devices at various locations describing wireless network performance at their respective locations, analyzing the data to identify one or more performance zones and providing guidance and/or recommendations to a mobile user device based on the performance zones proximate to the mobile user device. In at least some embodiments, the collected information can include other information, such as device type information and/or application usage in association with the performance data. Guidance and/or recommendations can include, without limitation, advisories, e.g., warning of nearby performance degradations and/or outages, navigation information, e.g., recommended alternate routes based on current and/or planned mobile services and/or advertisements of nearby alternative wireless services, e.g., Wi-Fi hotspots.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

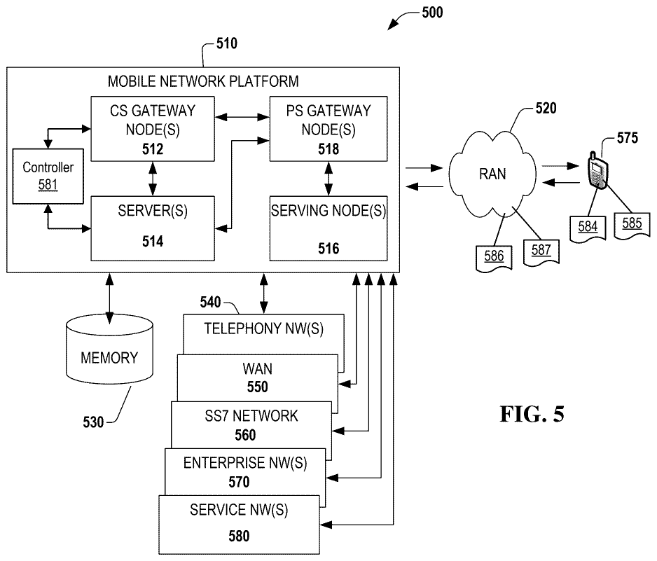

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving performance data from multiple wireless communication devices at various locations describing wireless network performance at their respective locations, analyzing the data to identify one or more performance zones and providing guidance and/or recommendations to a mobile user device based on the performance zones proximate to the mobile user device. In at least some embodiments, the collected information can include other information, such as device type information and/or application usage in association with the performance data. Guidance and/or recommendations can include, without limitation, advisories, e.g., warning of nearby performance degradations and/or outages, navigation information, e.g., recommended alternate routes based on current and/or planned mobile services and/or advertisements of nearby alternative wireless services, e.g., Wi-Fi hotspots. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a mobile device 575, e.g., a radiotelephone.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In at least some embodiments 500 the mobile network platform 510 can include a controller module 581 configured to support operation of one or more of the performance data collectors 180, 380, the performance data store 182, 382 and, in at least some embodiments, the mapping guidance module 183, 383 (FIGS. 1 and 3). In at least some embodiments, mobile devices 575 can be configured with one or more of a mobile wireless performance data monitoring application program (app) 584 or a mobile guided positioning app 586. The mobile apps 384, 385 can be configured according to other mobile apps described elsewhere herein, e.g., the mobile wireless performance data monitoring app 184 and/or the mobile guided positioning app 185 (FIG. 1). Likewise, in at least some embodiments, the RAN 520 can be configured with one or more of a wireless performance data monitoring app 586 or a guided positioning app 587. The example network-side apps 586, 587 can be configured according to other apps described elsewhere herein, e.g., the wireless performance data monitoring app 186 and/or the guided positioning app 187 (FIG. 1).

It is understood that one or more of the performance data collector 380, the performance data store 382 and/or the mapping guidance module 383 may be hosted in whole or in part at one or more of the example VNEs 330, 332, 334 and/or distributed across multiple VNEs 330, 332, 334. Alternatively, or in addition, one or more of the performance data collectors 380, the performance data store 382 and/or the mapping guidance module 383 may be hosted in whole or in part in the example cloud computing environment 375, e.g., as may be hosted at one or more data centers.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

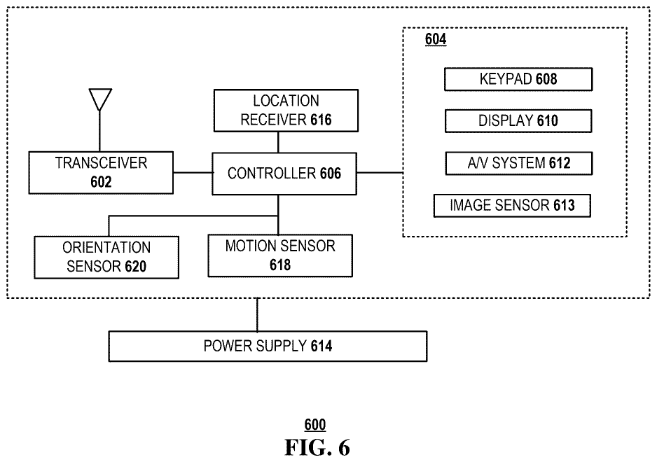

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving performance data from multiple wireless communication devices at various locations describing wireless network performance at their respective locations, analyzing the data to identify one or more performance zones and providing guidance and/or recommendations to a mobile user device based on the performance zones proximate to the mobile user device. In at least some embodiments, the collected information can include other information, such as device type information and/or application usage in association with the performance data. Guidance and/or recommendations can include, without limitation, advisories, e.g., warning of nearby performance degradations and/or outages, navigation information, e.g., recommended alternate routes based on current and/or planned mobile services and/or advertisements of nearby alternative wireless services, e.g., Wi-Fi hotspots.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

In at least some embodiments, a system, process and/or software can be configured to present to a device, e.g., along a route of travel, predicted wireless network performance data for a mobile communication device. The configuration can include one or more of receiving data describing the wireless network performance for one or more wireless collector devices, receiving data describing the location of the one or more wireless collector devices, analyzing the performance data and the location data to identify one or more performance zones, receiving location information from a subject user device, and sending to the subject user device data describing one or more performance zones proximate to the subject user device. Alternatively, or in addition, the location information received from the subject user device can be for a planned future location of the device, e.g., a later point along a planned route as may be determined according to a navigation solution. Alternatively, or in addition, the data describing the wireless network performance can include performance location data collected when at least one of the one or more wireless collector devices experienced an insufficient and/or o network signal. Alternatively, or in addition, the example system, process and/or software can be further configured to include sending data to the subject user device providing guidance to a nearby improved performance zone.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method for presenting to a device, along a route of travel, predicted wireless network performance data for the device, comprising:
receiving, by a processing system including a processor, network performance data of a wireless network observed by a plurality of wireless collector devices at a plurality of different locations, the network performance data describing performance of a wireless network at the plurality of different locations;
receiving, by the processing system, location data describing the plurality of different locations of the plurality of wireless collector devices;
differentiating, by the processing system, the network performance data into a plurality of differentiated network performance ranges;
analyzing, by the processing system, the network performance data and the location data according to the plurality of differentiated network performance ranges to identify one or more spatial performance zones according to the network performance data, the plurality of different locations, and the plurality of differentiated network performance ranges;
receiving, by the processing system, user location data originating from a mobile communication device; and
sending, by the processing system, performance-based information to the mobile communication device, wherein the performance-based information is based at least in part on the user location data and the one or more spatial performance zones.

2. The method of claim 1, further comprising:
determining, by the processing system, a device type of a plurality of device types for each wireless collector of the plurality of wireless collector devices.

3. The method of claim 2, wherein the device type comprises one of a device make, a device model, a device version, or any combination thereof.

4. The method of claim 2, further comprising:
differentiating further, by the processing system, the plurality of differentiated network performance ranges according to the plurality of device types.

5. The method of claim 1, further comprising:
receiving, by the processing system, location data describing the plurality of different locations of the plurality of wireless collector devices.

6. The method of claim 1, further comprising:
associating, by the processing system, the user location data with a map to obtain a first association;
associating, by the processing system, the one or more spatial performance zones with the map to obtain a second association; and
determining, by the processing system, the performance-based information based on the first and second associations.

7. The method of claim 1, further comprising:
determining, by the processing system, a route of the mobile communication device between two locations on a map, wherein the performance-based information comprises guidance information.

8. The method of claim 7, further comprising:
determining, by the processing system, a wireless service, wherein the guidance information is further based on the wireless service.

9. The method of claim 8, wherein the guidance information comprises a recommendation.

10. The method of claim 8, further comprising:
identifying, by the processing system, availability of an alternative network resource, wherein the guidance information is further based on the availability of the alternative network resource.

11. The method of claim 1, wherein the network performance data comprises one of a signal strength, a signal quality, a data speed or any combination thereof.

12. A device, comprising:
a processing system including a processor; and
a memory that stores executable instructions that, when executed by the processing system, facilitate performance of operations, the operations comprising:
obtaining network performance data of a wireless network determined by a plurality of wireless communication devices at a plurality of different locations, the network performance data describing performance of the wireless network at the plurality of different locations;
receiving location data describing the plurality of different locations of the plurality of wireless communication devices;
associating the network performance data with a plurality of performance ranges;
analyzing the network performance data and the location data according to the plurality of performance ranges to identify one or more spatial performance zones according to the network performance data, the plurality of different locations, and the plurality of performance ranges;
receiving user location data originating from a mobile device; and
sending performance-based information to the mobile device, wherein the performance-based information is based at least in part on the user location data and the one or more spatial performance zones.

13. The device of claim 12, further comprising:
determining device information for each wireless communication device of the plurality of wireless communication devices, wherein the plurality of performance ranges are further distinguished according to the device information.

14. The device of claim 13, wherein the device information comprises one of a wireless communication device make, a wireless communication device model, a wireless communication device version, or any combination thereof.

15. The device of claim 12, further comprising:
associating the user location data with a map to obtain a first association;
associating the one or more spatial performance zones with the map to obtain a second association; and
determining the performance-based information based on the first and second associations.

16. The device of claim 12, further comprising:
determining a path of the mobile device, wherein the performance-based information comprises guidance information according to the path.

17. The device of claim 12, wherein the network performance data comprises one of a signal strength, a signal quality, a data speed or any combination thereof.

18. A non-transitory machine-readable medium, comprising executable instructions that, when executed by a processing system including a processor, facilitate performance of operations, the operations comprising:
obtaining performance data of a wireless network determined by a plurality of wireless devices at a plurality of different locations, the performance data describing a performance of the wireless network at the plurality of different locations;
associating the network performance data with a plurality of performance ranges;
analyzing the network performance data according to the plurality of performance ranges to identify one or more spatial performance zones according to the performance data, the plurality of different locations, and the plurality of performance ranges;
determining user location data of a mobile device; and
determining performance-based information based at least in part on the user location data and the one or more spatial performance zones.

19. The non-transitory machine-readable medium of claim 18, wherein the operations further comprise:
associating the user location data with a map to obtain a first association;
associating the one or more spatial performance zones with the map to obtain a second association; and
determining the performance-based information based on the first and second associations.

20. The non-transitory machine-readable medium of claim 18, wherein the performance data comprises one of a signal strength, a signal quality, a data speed or any combination thereof.
